(19) United States
(12) Patent Application Publication
(10) Pub. No.: US 2003/0103796 A1
(43) Pub. Date: Jun. 5, 2003

(54) Ring binder ring locking

(75) Inventors: Chun On To, Hong Kong (HK); Hung Yu Cheng, Hong Kong (HK)

Correspondence Address: SENNIGER POWERS LEAVITT AND ROEDEL, ONE METROPOLITAN SQUARE, 16TH FLOOR, ST LOUIS, MO, 63102, US

(73) Assignee: World Wide Stationery Manufacturing Company, Limited

(21) Appl. No.: 09/998,447

(22) Filed: Nov. 30, 2001

(51) Int. Cl. B42F 3/04

(52) U.S. Cl. 402/38

(57) ABSTRACT

Ring binder mechanism with a ring-locking feature.

### BACKGROUND OF THE INVENTION

This invention relates to locking closed the rings of a ring binder, involving more particularly a ring binder with a ring-locking feature and a method of locking closed the ring segments of a ring binder.

The invention is especially directed toward the locking closed of the ring segments of a ring binder mechanism having certain components generally such as shown in the following U.S. Patents:

| Patent No. | Date | Title |
|---|---|---|
| 5,755,513 | May 26, 1998 | Ring Binder |
| 5,842,807 | Dec. 1, 1998 | Ring Binder |
| 6,033,144 | Mar. 7, 2000 | Ring Binder Mechanism |
| 6,168,339 B1 | Jan. 2, 2001 | Ring Binder |

### BRIEF SUMMARY OF THE INVENTION

Among the several objects of the invention may be noted the provision of a ring binder mechanism with a ring-locking instrumentality which is per se economical and relatively easy to manipulate for locking the rings closed and relatively easy to manipulate for unlocking the rings; the provision of a ring binder mechanism with such an instrumentality which is held captive when in its ring-unlocking state by the mechanism; and the provision of a method of locking (and unlocking) the rings of a ring binder mechanism involving simple manipulation.

In general, ring binder mechanism of the invention comprises an elongate face plate extending the length of the mechanism. This plate has a plurality of sets of holes spaced at intervals lengthwise thereof, each set comprising two holes, one adjacent each side of the plate. Pivot plates carried by the elongate face plate extend side-by-side underneath the latter, each pivoted at a respective side margin of the face plate for swinging movement between a lowered position angled downward from the respective side margin of the face plate and a raised position angled upward from the respective margin of the face plate. Pairs of binder ring segments extend from the pivot plates through the said holes, the two segments of each pair of binder ring segments being held in open position by the pivot plates when the latter are up in raised position and being closed in ring formation when the pivot plates are down in lowered position. The ring segments are locked closed by an insert extending through a hole of one of the sets of holes between the pivot plates and the face plate acting to lock the pivot plates down in lowered position and thereby lock the ring segments closed.

Other objects and features will be in part apparent and in part pointed out hereinafter.

### BRIEF DESCRIPTION OF THE DRAWINGS

FIG. 1 is a perspective illustrating a three-ring ring binder mechanism equipped with a locking instrumentality in accordance with the invention;

FIG. 2 is an enlarged fragment of FIG. 1, showing the locking instrumentality;

FIG. 3 is a view of FIG. 1 exploded;

FIG. 4 is a view of a modification of said instrumentality;

FIG. 5 is a view in transverse section generally on line 5—5 of FIGS. 1 and 2, showing ring segments closed and locked closed;

FIG. 6 is a view auxiliary to FIG. 5 showing the ring segments open;

FIG. 7 is a view similar to FIG. 1 showing a modification of the locking instrumentality;

FIG. 8 is an enlarged fragment of FIG. 7;

FIG. 9 is a view in transverse section through the center ring of FIGS. 7 and 8, showing ring segments closed and locked closed;

FIG. 10 is a view auxiliary to FIG. 9 showing the ring segments open; and

FIG. 11 is a perspective illustrating a three-ring ring binder mechanism of a second embodiment.

Corresponding reference characters indicate corresponding parts throughout the several views of the drawings.

### DETAILED DESCRIPTION

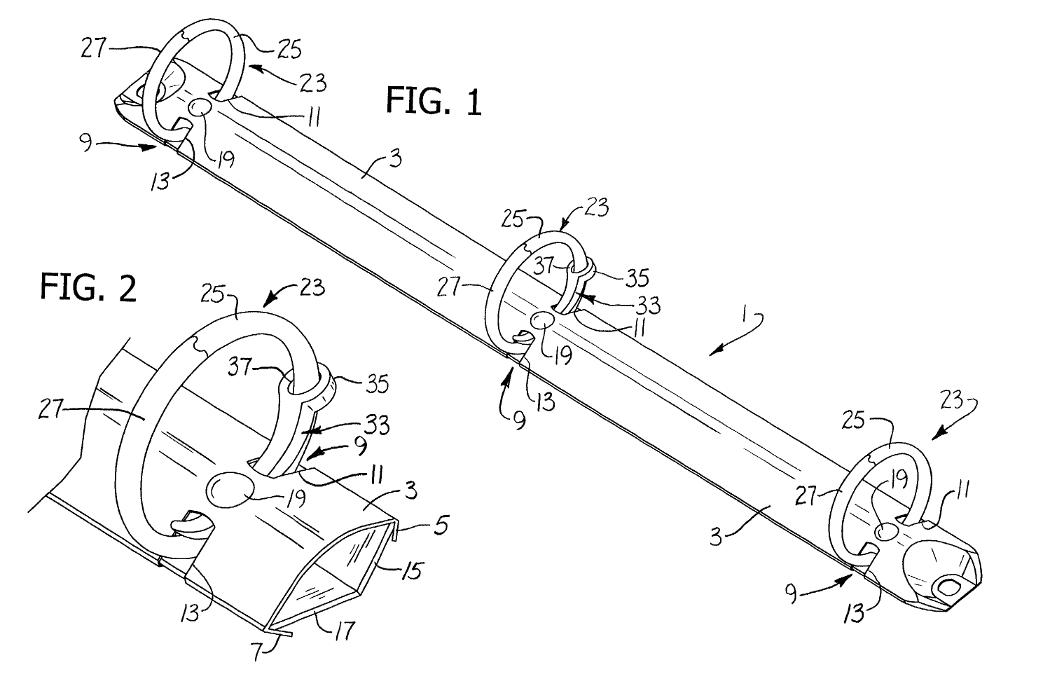

Referring principally to FIGS. 1, 3, 5 and 6 of the drawings, a ring binder mechanism with rings locked in accordance with this invention, designated 1 in its entirety, is shown to comprise an elongate plate 3, generally a sheet metal plate, which may be referred as the face plate or “spine” of the mechanism, extending the length of the mechanism. This plate 3, which is of arched conformation in transverse section, has inturned flanges 5, 7 on its sides extending its full length. Further, plate 3 has a plurality (three) sets of holes, each set being generally designated 9, spaced at intervals lengthwise thereof. There is a set adjacent each end and a set at the center of length of the plate 3. Each set 9 comprises two holes 11 and 13, one adjacent each side of the plate 3. The plate 3 carries two pivot plates 15 and 17. These extend side-by-side underneath the plate 3, each being pivoted at a respective side of plate 3 by having its outside lengthwise margins 15a, 17a captured between flanges 5, 7 and plate 3 for swinging movement between a lowered position (relative to plate 3) as shown in FIGS. 2 and 5 angled downward from the respective side margin of plate 3 and a raised position (relative to plate 3) as shown in FIG. 6 angled upward from the respective side margin of plate 3. The latter has indentations such as indicated at 19, one between the holes 11, 13 of each set 9 of holes. With the pivot plates 15, 17 in their lowered position (FIG. 6), their inside lengthwise margins are spaced downward below the bottoms of the indentations, the space being indicated at 21 in FIG. 5.

The ring binder mechanism 1 comprises a plurality of rings as indicated at 23, three such rings as shown (as usual in such mechanisms), one adjacent each end of the mechanism and one at the center of length of the mechanism. Each ring comprises two ring segments 25 and 27, each of these segments constituting the usual half-ring. The ring segments or half-rings 25, 27 extend from the pivot plates 15, 17, to which they are secured as indicated at 29 and 31, through the holes 11, 13. They are held in open position (spread apart) as shown in FIG. 6 by the pivot plates 15, 17 when the latter are up in raised position and are closed in ring formation as shown in FIGS. 1, 2 and 5 when the pivot plates 15, 17 are down in their lowered position. They are opened simply by pulling the half-rings apart, closed simply by pushing the half-rings together.

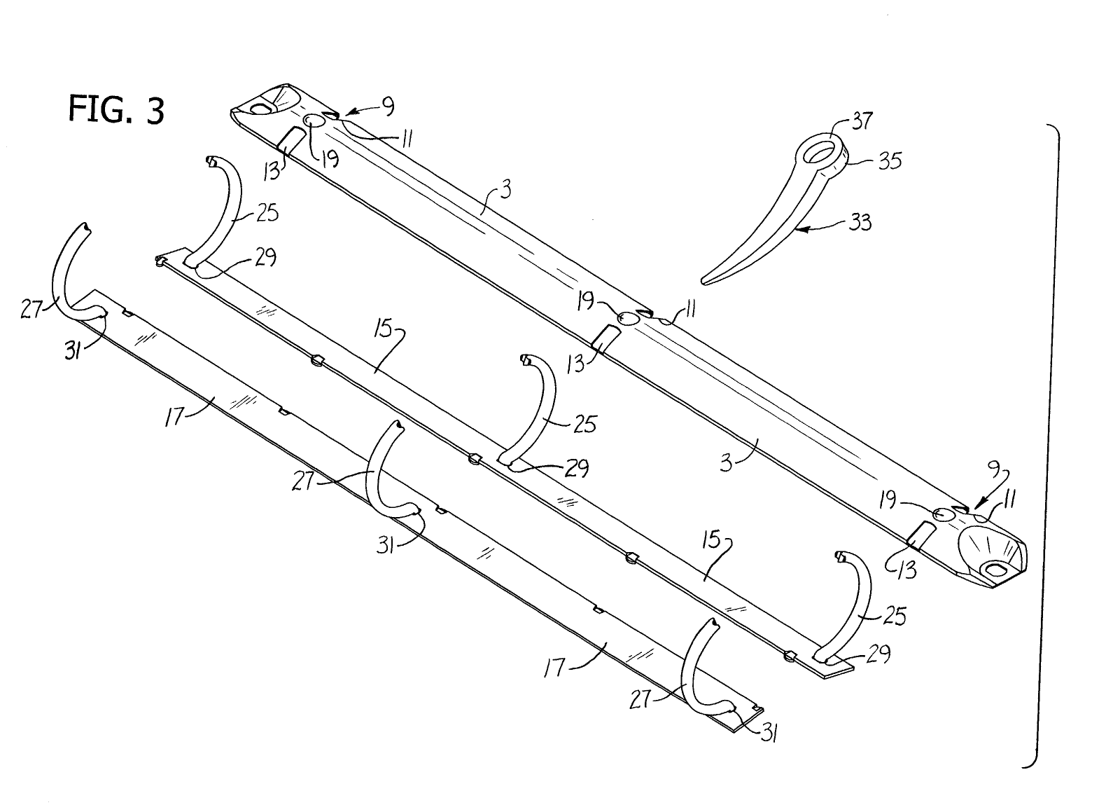

The ring segments 25, 27 (half-rings) are locked closed in accordance with this invention as shown in FIGS. 1, 2 and 5 by an insert 33 (which may also be referred to as a pin or peg) extending through the hole 11 and then slightly through hole 13 of one of the sets 9 of holes 11, 13, specifically the center set, plugging the space 21 between the pivot plates 15, 17 and the indentation 19 of the face plate 3 intermediate these two holes. Insert 33 essentially comprises an elongate member long enough to traverse both holes and of such transverse cross-sectional formation as to fit in the holes and to lock the pivot plates down. It comprises a length of material suitable for the purpose, generally a length of flexible material and preferably a length of flexible plastic material such as nylon. As best appears in FIGS. 3, 5 and 6, the insert is of tapered formation both widthwise and thickness-wise, thus being generally of wedge shape. It has a head 35 at its outer end slidably captive on the half-ring (ring segment) 25 of the center ring 23. The head 35 has an opening or eye 37 for the reception of the ring segment or half-ring 25 of the central ring 23. As shown, the head 35 is in the form of a ring generally coplanar with the insert.

All three rings 23 being open, including the central ring 23 as shown in FIG. 6, and the insert 33 out of the holes 11, 13 for the central ring 23, the insert may occupy a position swung around the half-ring 25 of the central ring and extending outward therefrom to one side of the mechanism 1. The rings 23 may be snapped closed and locked closed by sliding the insert 33 up on the central half-ring 25 from the FIG. 6 position, turning it around 1800, and inserting it through hole 11 of the central set 9, pushing it in to the point as shown in FIG. 5 where the tip of the insert just enters the respective hole 13. This is permitted by the flexibility of the insert. As appears in FIG. 5, the insert 33 (with its wedge shape) plugs the space 21 between the inner margins of the pivot plates 15, 17 and the face plate 3 (more particularly the bottom of the central indentation 19 of the face plate) and thus locks the pivot plates 15, 17 down in their lowered position thereby precluding upward movement of the pivot plates and thus locking all three of the rings closed.

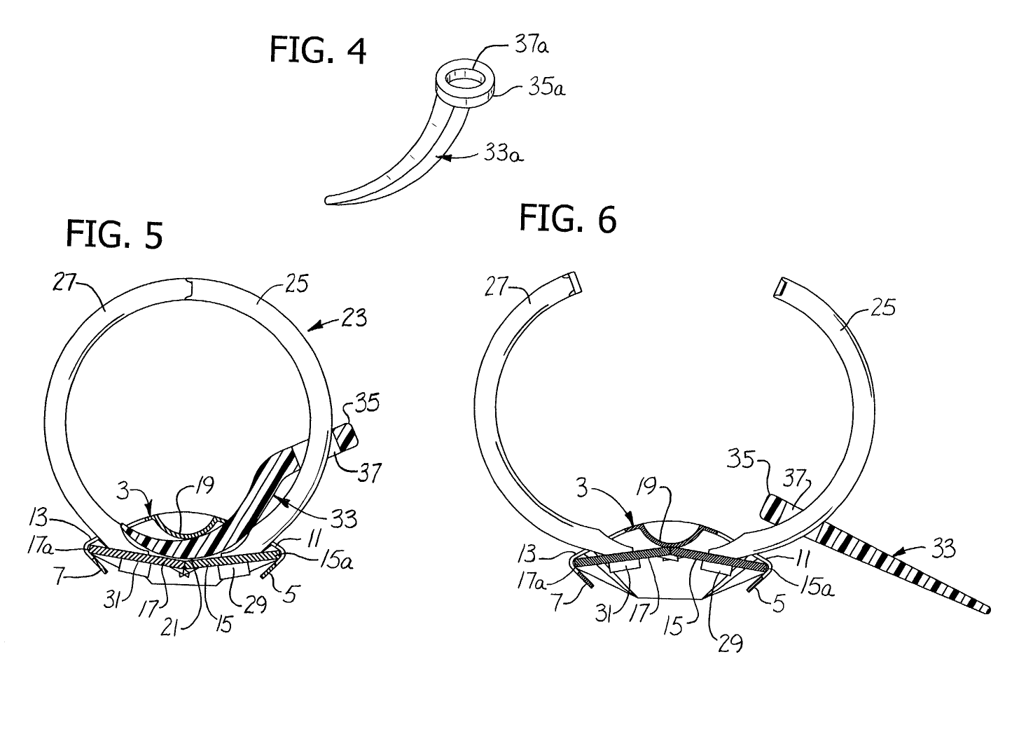

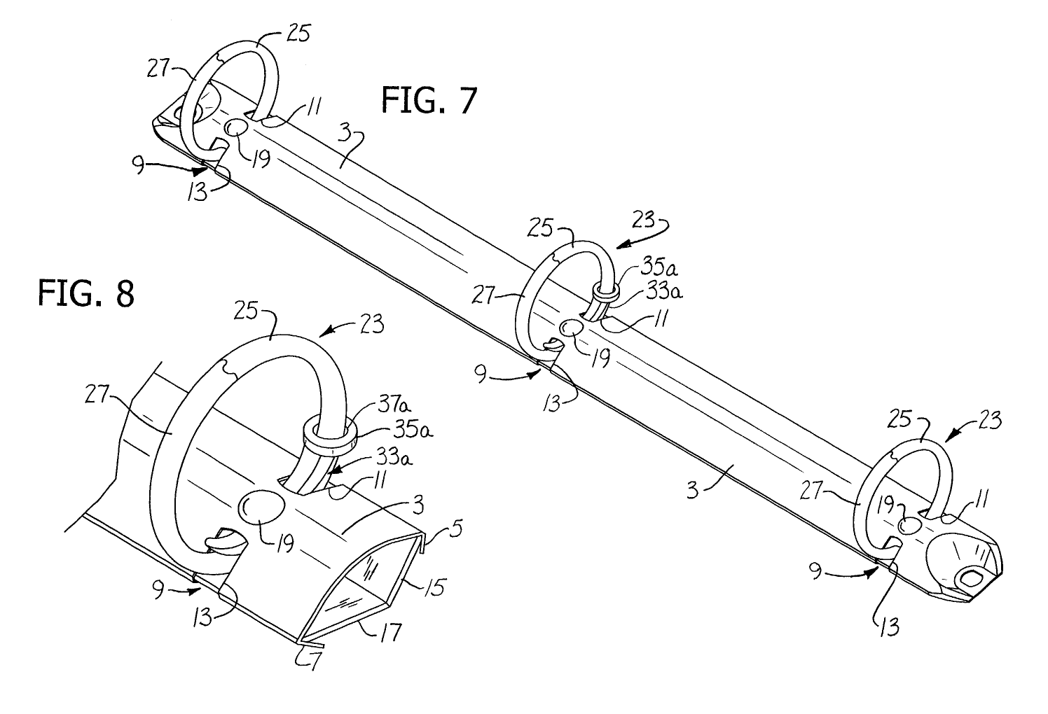

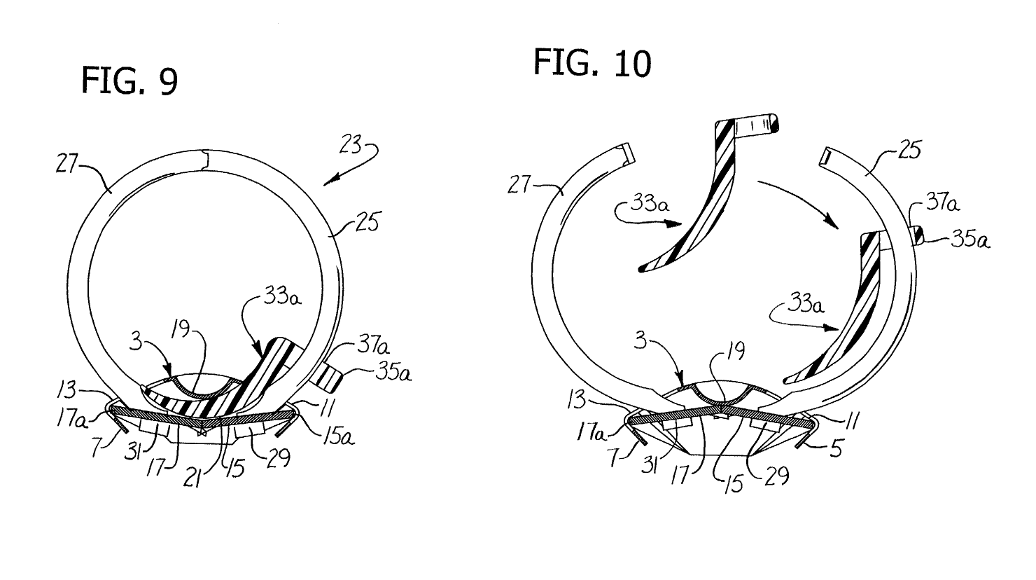

FIG. 4 shows a modification 33a of the insert 33 and FIGS. 7-10 show insert 33a on the central half-ring 25, 33a differing from 33 in that its head 35a with opening or eye 37a is oriented generally at right angles with respect to the length of the insert. This makes for manipulation as illustrated in FIG. 10.

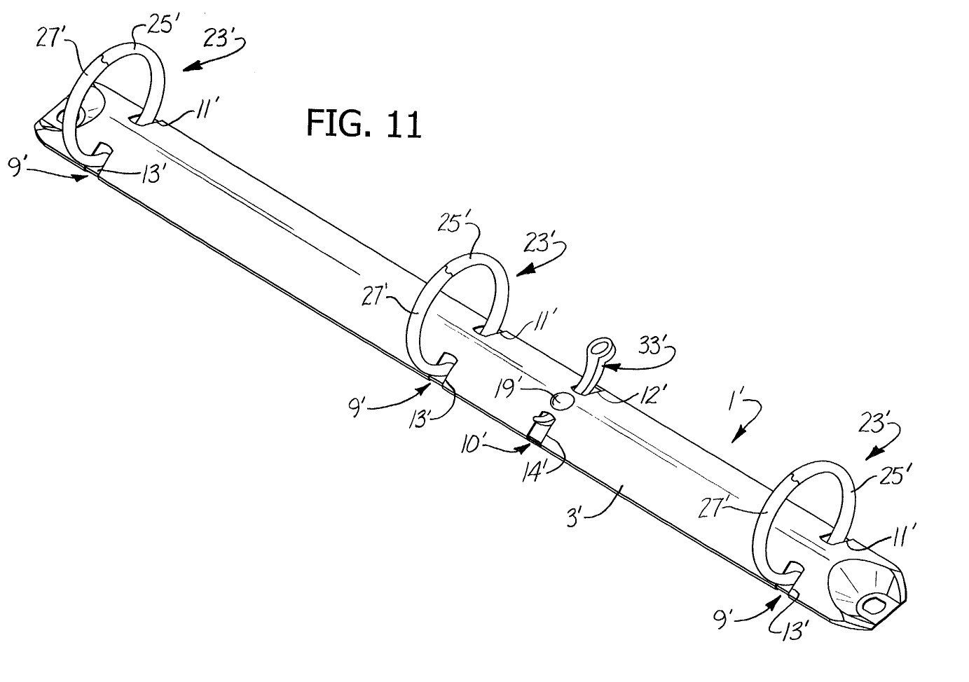

FIG. 11 shows a ring binder mechanism of a second embodiment, designated generally at 1′. Corresponding parts of the ring binder mechanism 1′ of the second embodiment will be designated by the same reference characters as for the first embodiment, but with a prime (“′”) following the character. The construction of the ring binder mechanism 1′ is substantially the same as that of the first embodiment. However, the holes 11′, 13′ through which the ring segments 25′, 27′ extend are not used for reception of the insert 33′. Instead a set 10′ comprising a pair of holes, designated 12′ and 14′, respectively, is dedicated for reception of the insert 33′. Thus, the insert 33′ does not have to be inserted through the same holes 11′, 14′ which receive the ring segments 25′, 27′. The indentation 19′ is provided solely for the set 10′, but could also be present at the location of each ring 23′, as with the first embodiment.

In view of the above, it will be seen that the several objects of the invention are achieved and other advantageous results attained.

As various changes could be made in the above described constructions and method without departing from the scope of the invention, it is intended that all matter contained in the above description and shown in the accompanying drawings shall be interpreted as illustrative and not in a limiting sense.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. Ring binder mechanism comprising an elongate face plate extending the length of the mechanism, pivot plates carried by the elongate face plate extending side-by-side underneath the latter each pivoted at a respective side margin of the face plate for swinging movement between a lowered position angled downward from the respective side margin of the face plate and a raised position angled upward from the respective margin of the face plate, at least one pair of binder ring segments extending from the pivot plates, the two segments of said at least one pair of binder ring segments being held in open position by the pivot plates when the latter are up in raised position and being closed in ring formation when the pivot plates are down in lowered position, a hole in the plate, an insert sized and shaped for reception into said hole into a position blocking movement of the pivot plates from the lowered position to the raised position thereby locking said ring segments in closed position.

2. Ring binder mechanism with the ring-locking insert of claim 1 the insert is receivable through the hole into a space between the pivot plates and the face plate.

3. Ring binder mechanism with the ring-locking insert of claim 2 wherein the insert comprises an elongate member constituting a length of flexible material.

4. Ring binder mechanism with the ring-locking insert of claim 3 wherein said elongate member has a head slidably captive on one of the ring segments.

5. Ring binder mechanism with the ring-locking insert of claim 4 wherein the head has a hole receiving said one of the ring segments.

6. Ring binder mechanism as set forth in claim 1 wherein the hole is a member of a set of holes including another hole, each hole of the set being adjacent a respective side of the plate, and wherein the elongate plate includes plural sets of said holes spaced at intervals along the length of the mechanism, said ring segments being received through corresponding ones of the holes

7. Ring binder mechanism as set forth in claim 6 wherein the face plate is arched in transverse cross-section and has an indentation between the holes of the set where the insert is used, there being a space between the indentation and the pivot plates when they are down in their lowered position, said insert plugging said space and locking the pivot plates down thereby locking the ring segments closed.

8. Ring binder mechanism with the insert of claim 7 wherein said insert is of wedge formation tapering both as to width and thickness.

9. Ring binder mechanism with the insert of claim 8 wherein said insert is made of flexible material and has a head with an opening for reception of one of the ring segments.

10. Ring binder mechanism with the insert of claim 9 wherein the insert is of such length as to extend through both holes of said one set.

11. Ring binder mechanism with the insert of claim 9 wherein the head comprises a ring generally coplanar with the insert.

12. Ring binder mechanism with the insert of claim 9 wherein the head comprises a ring generally at right angles to the length of the insert.

13. The method of locking the ring segments of a ring binder mechanism closed, said ring binder mechanism comprising an elongate face plate extending the length of the mechanism, said plate having a hole therein, pivot plates carried by the elongate face plate extending side-by-side underneath the latter each pivoted at a respective side margin of the face plate for swinging movement between a lowered position angled downward from the respective side margin of the face plate and a raised position angled upward from the respective margin of the face plate, at least one pair of binder ring segments extending from the pivot plates, the two segments of the pair of binder ring segments being held in open position by the pivot plates when the latter are up in raised position and being closed in ring formation when the pivot plates are down in lowered position, said method comprising manipulating an insert to extend through the hole between the pivot plates and the face plate acting to lock the pivot plates down in lowered position and thereby lock the ring segments closed.

14. The method of claim 13 wherein the insert is generally wedged between the pivot plates and the face plate.

15. The method of claim 13 applicable to a ring binder mechanism wherein the face plate is arched in transverse cross-section, the hole is part of a set of holes including another hole, each hole of the set being adjacent a respective side of the plate, the face plate having an indentation between the holes of the set where the insert is used, there being a space between the indentation and the pivot plates when they are down in their lowered position, said insert plugging said space and locking the pivot plates down thereby locking the ring segments closed.

16. The method of claim 15 wherein the insert is pushed in far enough to extend through the other hole of said one set.
